(19) United States
(12) Patent Application Publication
(10) Pub. No.: US 2023/0211414 A1
(43) Pub. Date: Jul. 6, 2023

(54) PRODUCING POLYCRYSTALLINE DIAMOND COMPACT (PDC) DRILL BITS WITH CATALYST-FREE AND SUBSTRATE-FREE PDC CUTTERS

(71) Applicants: Saudi Arabian Oil Company, Dhahran (SA); Chengdu Dongwei Technology Co., LTD, Chengdu (CN)

(72) Inventors: Guodong Zhan, Dhahran (SA); Jianhui Xu, Dhahran (SA); Timothy E. Moellendick, Dhahran (SA); Duanwei He, Chengdu (CN)

(21) Appl. No.: 17/567,531

(22) Filed: Jan. 3, 2022

(51) Int. Cl. B22F 7/00; B22F 7/02; B22F 3/24

(52) U.S. Cl. CPC B22F 7/008; B22F 7/02; B22F 3/24; B22F 2003/247; B22F 2302/406

(57) ABSTRACT

Methods for forming a polycrystalline diamond compact (PDC) drill bit from catalyst-free synthesized polycrystalline diamonds are described. The polycrystalline diamonds are deposited within a mold. In some cases, a matrix body material is deposited within the mold, and an infiltration process is performed to bond the polycrystalline diamonds to the matrix body material to form the PDC drill bit. In some cases, a drill bit body is formed within the mold, and forming the drill bit body within the mold includes depositing a layer of matrix body material particles within the mold, depositing an adhesive ink within the mold, and curing the adhesive ink. In some cases, a sintering process is performed after forming the drill bit body to remove at least a portion of the adhesive ink and increase a density of the drill bit body to form the PDC drill bit.

### TECHNICAL FIELD

This disclosure relates to production of polycrystalline diamond compact (PDC) drill bits and, particularly, PDC drill bits for the oil and gas industry.

### BACKGROUND

Drilling hard, abrasive, and interbedded formations poses a difficult challenge for conventional PDC drill bits where the PDC cutter is formed using conventional high pressure and high temperature (HPHT) technology. Historically, a conventional polycrystalline diamond material, generally forming a cutting layer, also called diamond table, dulls quickly due to abrasive wear, impact damage, and thermal fatigue. Thus, hardness, fracture toughness, and thermal stability of polycrystalline diamond materials represent three limiting factors for an effective PDC drill bit.

### SUMMARY

Certain aspects of the subject matter described can be implemented as a method. Catalyst-free synthesized polycrystalline diamonds are provided. Each of the polycrystalline diamonds have a cross-sectional dimension of at least 4 millimeters. The polycrystalline diamonds are deposited within a mold. After depositing the polycrystalline diamonds within the mold, a matrix body material is deposited within the mold. An infiltration process is performed to bond the polycrystalline diamonds to the matrix body material and form a polycrystalline diamond compact (PDC) drill bit. The infiltration process includes heating the polycrystalline diamonds and the matrix body material deposited within the mold to an infiltration temperature greater than about 700 degrees Celsius (° C.) and less than about 1400° C.

This, and other aspects, can include one or more of the following features. In some implementations, providing the polycrystalline diamonds includes synthesizing each of the polycrystalline diamonds from diamond powder with a particle size within a range of from about 0.1 micrometers (μm) to about 50 μm. In some implementations, providing the polycrystalline diamonds includes shaping each of the synthesized polycrystalline diamonds by laser cutting or mechanical grinding. In some implementations, for each of the polycrystalline diamonds, the cross-sectional dimension of at least 4 millimeters is a first cross-sectional dimension, and each of the polycrystalline diamonds has a second cross-sectional dimension that is greater than the first cross-sectional dimension. In some implementations, the infiltration temperature is less than about 800° C. In some implementations, the infiltration temperature is about 800° C. In some implementations, the infiltration process includes heating the polycrystalline diamonds and the matrix body material deposited within the mold at a heating rate in a range of from about 1° C. per minute (° C./min) to about 40° C./min until the polycrystalline diamonds and the matrix body material deposited within the mold reach the infiltration temperature. In some implementations, the infiltration process includes maintaining the polycrystalline diamonds and the matrix body material deposited within the mold at the infiltration temperature for an infiltration time duration in a range of from about 10 minutes to about 180 minutes. In some implementations, the infiltration process includes cooling the polycrystalline diamonds and the matrix body material deposited within the mold at a cooling rate in a range of from about −1° C./min to about −40° C./min after maintaining the polycrystalline diamonds and the matrix body material deposited within the mold at the infiltration temperature for the infiltration time duration. In some implementations, the infiltration process includes removing the formed PDC drill bit from the mold.

Certain aspects of the subject matter described can be implemented as a method. Catalyst-free synthesized polycrystalline diamonds are provided. Each of the polycrystalline diamonds have a cross-sectional dimension of at least 4 millimeters. The polycrystalline diamonds are deposited within a mold. After depositing the polycrystalline diamonds within the mold, a drill bit body is formed within the mold. Forming the drill bit body within the mold includes (a) depositing a layer of matrix body material particles within the mold, (b) depositing an adhesive ink within the mold, (c) curing the adhesive ink, and (d) repeating (a), (b), and (c) in order until the drill bit body is formed. After forming the drill bit body, a sintering process is performed to remove at least a portion of the adhesive ink and increase a density of the drill bit body to form a PDC drill bit. The sintering process includes heating the polycrystalline diamonds and the drill bit body to a sintering temperature greater than about 600° C. and less than about 1400° C.

This, and other aspects, can include one or more of the following features. In some implementations, providing the polycrystalline diamonds includes synthesizing each of the polycrystalline diamonds from diamond powder with a particle size within a range of from about 0.1 micrometers (μm) to about 50 μm. In some implementations, providing the polycrystalline diamonds includes shaping each of the synthesized polycrystalline diamonds by laser cutting or mechanical grinding. In some implementations, for each of the polycrystalline diamonds, the cross-sectional dimension of at least 4 millimeters is a first cross-sectional dimension, and each of the polycrystalline diamonds has a second cross-sectional dimension that is greater than the first cross-sectional dimension. In some implementations, the sintering temperature is less than about 1000° C. In some implementations, the sintering temperature is about 750° C. In some implementations, the sintering process includes heating the polycrystalline diamonds and the drill bit body at a heating rate in a range of from about 1° C./min to about 40° C./min until the polycrystalline diamonds and the drill bit body reach the sintering temperature. In some implementations, the sintering process includes maintaining the polycrystalline diamonds and the drill bit body at the sintering temperature for a sintering time duration in a range of from about 10 minutes to about 360 minutes. In some implementations, the sintering process includes cooling the polycrystalline diamonds and the drill bit body at a cooling rate in a range of from about −1° C./min to about −40° C./min after maintaining the polycrystalline diamonds and the drill bit body at the sintering temperature for the sintering time duration.

The details of one or more implementations of the subject matter of this disclosure are set forth in the accompanying drawings and the description. Other features, aspects, and advantages of the subject matter will become apparent from the description, the drawings, and the claims.

### DESCRIPTION OF DRAWINGS

FIG. 1 is a perspective view of an example drill bit used in the oil and gas industry for forming a wellbore.

FIG. 2A is a perspective view of an example PDC cutter.

FIG. 2B is a side view of the example PDC cutter of FIG. 2A.

FIG. 3A is a perspective view of an example PDC cutter.

FIG. 3B is a side view of the example PDC cutter of FIG. 3A.

FIG. 4A is a perspective view of an example PDC cutter.

FIG. 4B is a side view of the example PDC cutter of FIG. 4A.

FIG. 5A is a schematic diagram of an example PDC drill bit including an example PDC cutter being formed.

FIG. 5B is a flow chart of an example method for forming a PDC drill bit including a PDC cutter.

FIG. 6A is a schematic diagram of an example PDC drill bit including an example PDC cutter being formed.

FIG. 6B is a flow chart of an example method for forming a PDC drill bit including a PDC cutter.

### DETAILED DESCRIPTION

This present disclosure relates to the manufacture of drill bits used for oil and gas wellbore formation. The drill bits disclosed include catalyst-free polycrystalline diamond materials. The polycrystalline diamond materials are formed from nano-sized and micro-sized diamond particles and are formed using an ultra-high pressure and high temperature (UHPHT) technology. The formed polycrystalline diamond materials provide superior abrasive wear, impact damage, and thermal fatigue, thereby overcoming the deficiencies of current polycrystalline diamond materials formed using the high pressure, high-temperature (HPHT) technology. In some instances, the polycrystalline diamond material has a hardness of single-crystal diamond, which is more than twice as hard as the hardness of current polycrystalline diamond compact (PDC) cutters. Additionally, in some instances, the polycrystalline diamond produced using the UHPHT technology has a fracture toughness that approaches that of metallic materials. Further, the catalyst-free PDC cutter described can have superior thermal resistance for temperatures of up to 1400 degrees Celsius (° C.) in the presence of air in comparison to conventional PDC cutters. The enhanced thermal resistance of the catalyst-free PDC cutter described can allow the PDC cutter to be implemented by a pre-loaded method in manufacturing without risk of thermal degradation. As a result, the polycrystalline diamond material of the present disclosure provides increased drill bit performance, improved drill bit life, and improved cutting efficiency.

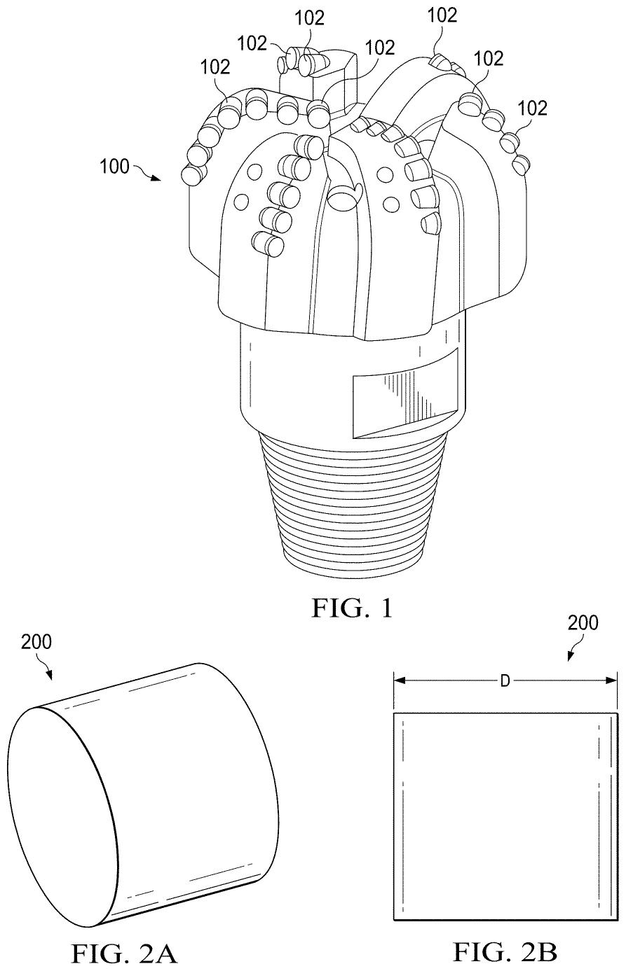

FIG. 1 is a perspective view of an example drill bit 100 used in the oil and gas industry for forming a wellbore. The drill bit 100 includes a plurality of PDC cutters 102. The PDC cutters 102 operate to cut into rock to form a wellbore. The PDC cutters 102 are synthesized free of a catalyst. That is, the PDC cutters 102 are synthesized without the use of a catalyst, such as catalysts based from cobalt, nickel, a Group VIII metal (for example, iron, ruthenium, osmium, and hassium) or any of their alloys, aluminum, titanium, chromium, manganese, tantalum, nickel aluminide (Ni₃Al), or boron-containing nickel aluminide. The PDC cutters 102 are formed from a polycrystalline diamond material formed using UHPHT technology. In some implementations, the UHPHT technology involves forming the polycrystalline diamond material using compressive pressures within a range of 10 gigapascals (GPa) to 35 GPa and temperatures within a range of 2000 Kelvin (K) to 3000 K.

FIG. 2A is a perspective view of an example PDC cutter 200. One or more of the PDC cutters 102 of drill bit 100 shown in FIG. 1 can be implementations of the PDC cutter 200 shown in FIG. 2A. FIG. 2B is a side view of the example PDC cutter of FIG. 2A. In some implementations, the PDC cutter 200 is disc-shaped. The PDC cutter 200 includes a polycrystalline diamond layer and is free of a substrate. As mentioned previously, the PDC cutter 200 is formed without the use of a catalyst. In some implementations, the polycrystalline diamond layer has a thickness within a range of from 2 millimeters (mm) to 4 mm. In some implementations, the polycrystalline diamond layer has a thickness greater than 4 mm or less than 2 mm.

In the illustrated example of FIGS. 2A and 2B, the PDC cutter 200 has a circular cross-sectional shape. A cross-sectional dimension (for example, diameter) D of the PDC cutter 200 may vary according to a desired size of the PDC cutter 200. In some implementations, the PDC cutter 200 has a cross-sectional dimension D within a range of from 4 mm to 48 mm. In some implementations, the cross-sectional dimension D of the PDC cutter 200 is greater than 48 mm or less than 4 mm. As shown in FIG. 2A, the PDC cutter 200 can have a cylindrical shape. In some implementations, the cross-sectional shape of the PDC cutter 200 may be other than circular. In some implementations, the PDC cutter 200 has a non-circular cross-sectional shape. For example, the PDC cutter 200 may be oval, square, rectangular, or have an irregular shape. The cross-sectional dimension of the PDC cutter 200 may be within a range of from 4 mm to 48 mm.

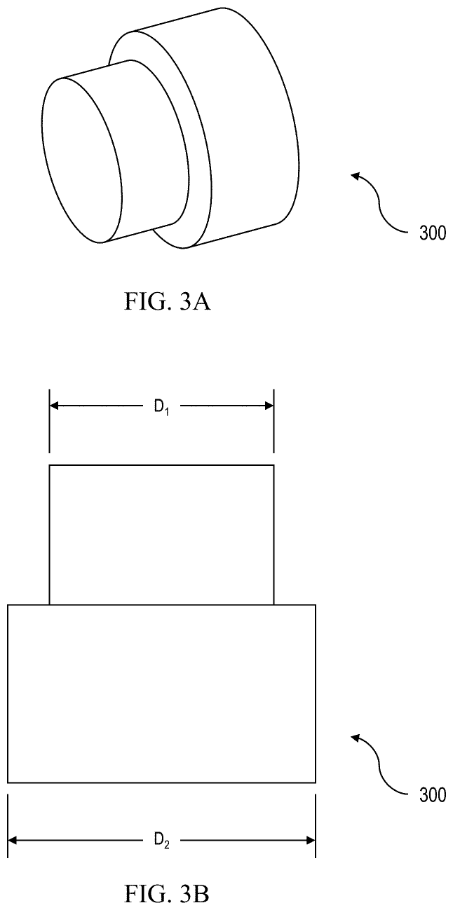

FIG. 3A is a perspective view of an example PDC cutter 300. One or more of the PDC cutters 102 of drill bit 100 shown in FIG. 1 can be implementations of the PDC cutter 300 shown in FIG. 3A. PDC cutter 300 can be substantially similar to PDC cutter 200. For example, PDC cutter 300 is substantially the same as PDC cutter 200 but simply has a different shape and dimensions from PDC cutter 200. FIG. 3B is a side view of the example PDC cutter of FIG. 3A. In some implementations, a first cross-sectional dimension (D₁) of the PDC cutter 300 is at least 4 millimeters. In some implementations, a second cross-sectional dimension (D₂) is greater than the first cross-sectional dimension, D₁. In some implementations, D₂ is at least 0.5 mm greater than D₁. Similar to PDC cutter 200, the PDC cutter 300 can have a non-circular cross-sectional shape. For example, the PDC cutter 300 can have an oval, a square, a rectangular, or an irregular shape. In such implementations, the non-circular cross-sectional shape can have a step width that is at least 0.25 mm for each and every side.

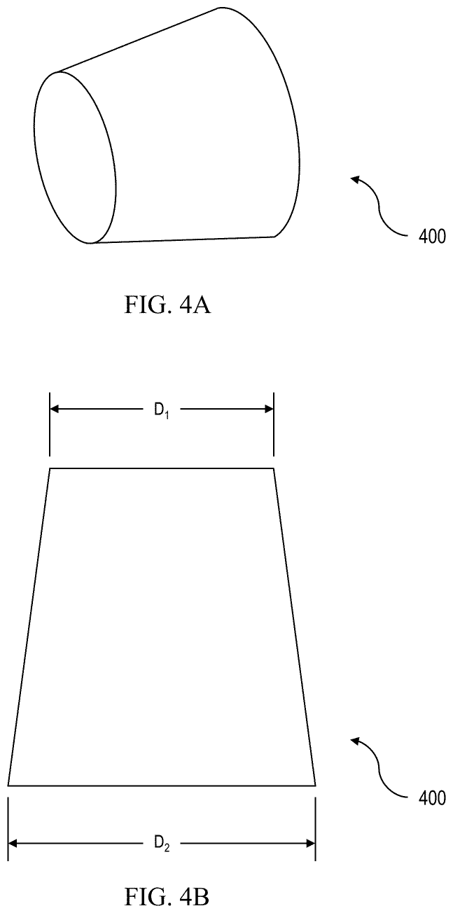

FIG. 4A is a perspective view of an example PDC cutter 400. One or more of the PDC cutters 102 of drill bit 100 shown in FIG. 1 can be implementations of the PDC cutter 400 shown in FIG. 4A. PDC cutter 400 can be substantially similar to PDC cutter 200 and/or PDC cutter 300. For example, PDC cutter 400 is substantially the same as PDC cutter 200 and/or 300 but simply has a different shape and dimensions from PDC cutter 200 and/or 300. FIG. 4B is a side view of the example PDC cutter of FIG. 4A.

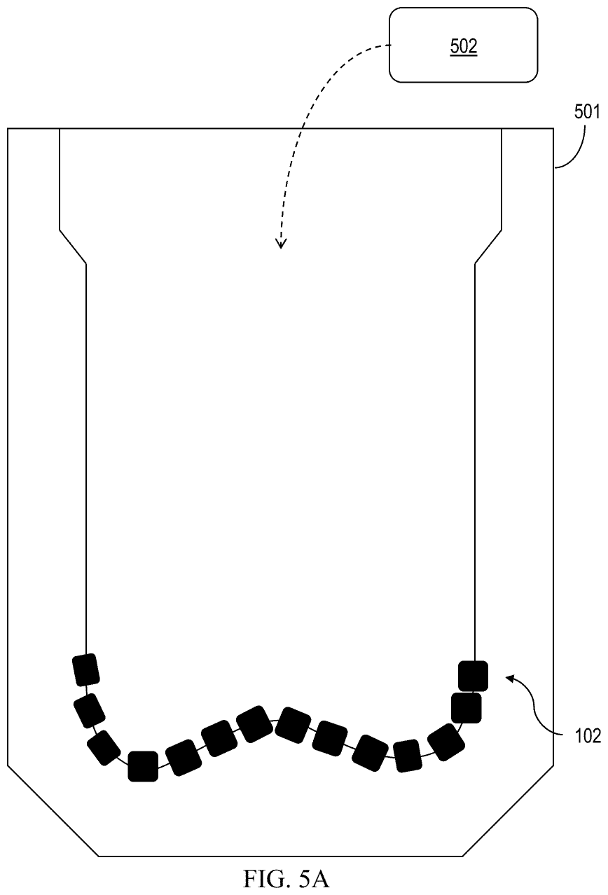

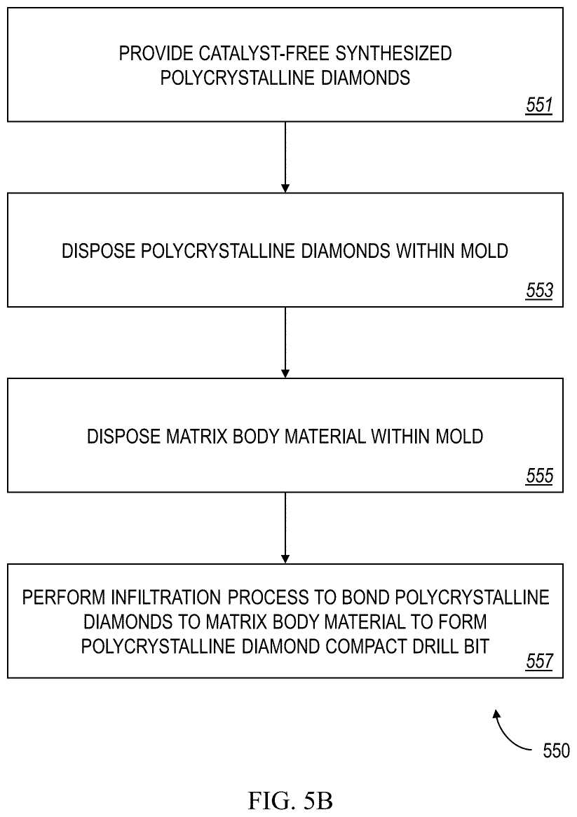

FIG. 5A is a schematic diagram of an example PDC drill bit being formed. In FIG. 5A, the plurality of PDC cutters 102 are already deposited within the mold 501. As mentioned previously, one or more of the PDC cutters 102 can be implementations of the PDC cutter 200, 300, 400, or any combination of these. For example, all of the PDC cutters 102 can be implementations of the PDC cutter 200. For example, all of the PDC cutters 102 can be implementations of the PDC cutter 300. For example, all of the PDC cutters 102 can be implementations of the PDC cutter 400. For example, some of the PDC cutters 102 can be implementations of the PDC cutter 200 while others can be implementations of the PDC cutter 300. For example, some of the PDC cutters 102 can be implementations of the PDC cutter 200 while others can be implementations of the PDC cutter 400. For example, some of the PDC cutters 102 can be implementations of the PDC cutter 300 while others can be implementations of the PDC cutter 400. For example, some of the PDC cutters 102 can be implementations of the PDC cutter 200, some of the PDC cutters 102 can be implementations of the PDC cutter 300, and the remaining PDC cutters 102 can be implementations of the PDC cutter 400.

With the PDC cutters 102 deposited within the mold 501, a matrix body material 502 is deposited within the mold 501. For example, the matrix body material 502 is poured in liquid form into the mold 501. Once the matrix body material 502 and the PDC cutters 102 have been deposited within the mold 501, an infiltration process can be performed to bond the PDC cutters 102 to the matrix body material 502 and form a PDC drill bit, for example, the PDC drill bit 100 shown in FIG. 1. The infiltration process is described in more detail later. The matrix body material 502 can be made of, for example, copper, nickel, cobalt, iron, molybdenum, titanium, or an alloy based on any of these metals individually or any combination of these metals. In some implementations, the matrix body material 502 includes an alloying element, such as manganese, tin, zinc, silicon, tungsten, boron, phosphorus, or any combination of these elements. In implementations in which certain levels of hardness, wear resistance, and erosion resistance are desired, additional “hard” particles can be provided as a reinforcement phase to the matrix body material 502. Such hard particles can include a carbide, such as tungsten carbide, silicon carbide, molybdenum carbide, titanium carbide, niobium carbide, tantalum carbide, chromium carbide, vanadium carbide, or any combination of these carbides. In some implementations, the hard particles include an oxide, a nitride, a silicide, a boride, or any combination of these compounds.

FIG. 5B is a flow chart of an example method 550 for forming a PDC drill bit (such as the PDC drill bit 100) including a PDC cutter (such as the PDC cutter 200, 300, or 400). At block 551 a plurality of catalyst-free synthesized polycrystalline diamonds are provided. Each of the polycrystalline diamonds provided at block 551 have a cross-sectional dimension of at least 4 millimeters. For example, a plurality of the PDC cutters 200 are provided at block 551. For example, a plurality of the PDC cutters 300 are provided at block 551. For example, a plurality of the PDC cutters 400 are provided at block 551. For example, a plurality of the PDC cutters 200 and a plurality of the PDC cutters 300 are provided at block 551. For example, a plurality of the PDC cutters 200 and a plurality of the PDC cutters 400 are provided at block 551. For example, a plurality of the PDC cutters 300 and a plurality of the PDC cutters 400 are provided at block 551. For example, a plurality of the PDC cutters 200, a plurality of the PDC cutters 300, and a plurality of PDC cutters 400 are provided at block 551.

In some implementations, providing the plurality of polycrystalline diamonds at block 551 includes synthesizing each of the polycrystalline diamonds from diamond powder with a particle size within a range of from about 0.1 micrometers (μm) to about 50 μm. In some implementations, providing the plurality of polycrystalline diamonds at block 551 includes shaping each of the synthesized polycrystalline diamonds by laser cutting or mechanical grinding. In some implementations, the cross-sectional dimension of at least 4 millimeters for each of the polycrystalline diamonds provided at block 551 is a first cross-sectional dimension, and each of the polycrystalline diamonds has a second cross-sectional dimension greater than the first cross-sectional dimension. Examples of such implementations are shown by PDC cutters 300 (shown in FIGS. 3A and 3B) and 400 (shown in FIGS. 4A and 4B).

At block 553, the plurality of polycrystalline diamonds (provided at block 551) is deposited within a mold (such as the mold 501). After depositing the plurality of polycrystalline diamonds within the mold 501 at block 553, a matrix body material (such as the matrix body material 502) is deposited within the mold 501 at block 555. For example, the matrix body material 502 is poured in liquid form into the mold 501 at block 555.

At block 557, an infiltration process is performed to bond the plurality of polycrystalline diamonds to the matrix body material 502 and form the PDC drill bit 100. The infiltration process at block 557 includes heating the plurality of polycrystalline diamonds and the matrix body material 502 deposited within the mold 501 to an infiltration temperature that is greater than about 700° C. and less than about 1400° C. In some implementations, the infiltration temperature is less than about 800° C. In some implementations, the infiltration temperature is in a range of from about 700° C. to about 800° C. In some implementations, the infiltration temperature is about 700° C. In some implementations, the infiltration temperature is about 750° C. In some implementations, the infiltration temperature is about 800° C.

The infiltration process at block 557 is a controlled diffusion process. In order to achieve complete penetration, the infiltration process at block 557 requires sufficient time to complete. Further, organic material in powder form evaporates during the infiltration process at block 557, and the evaporation requires sufficient time to complete as well. In some implementations, the infiltration process at block 557 includes heating the plurality of polycrystalline diamonds and the matrix body material 502 deposited within the mold 501 at a heating rate in a range of from about 1° C. per minute (° C./min) to about 40° C./min until the plurality of polycrystalline diamonds and the matrix body material 502 deposited within the mold 501 reach the infiltration temperature. In some implementations, the heating rate for the infiltration process at block 557 is in a range of from about 2° C./min to about 20° C./min, from about 3° C./min to about 15° C./min, or from about 5° C./min to about 10° C./min. In some implementations, the infiltration process at block 557 includes maintaining the plurality of polycrystalline diamonds and the matrix body material 502 deposited within the mold 501 at the infiltration temperature for an infiltration time duration in a range of from about 10 minutes to about 180 minutes. In some implementations, the infiltration time duration for the infiltration process at block 557 is in a range of from about 20 minutes to about 120 minutes or from about 30 minutes to about 60 minutes. Heating at quicker heating rates and/or carrying out the infiltration process for time durations that are shorter at block 557 may result in trapping organic vapor in the matrix body material 502 (which starts in liquid form at block 555), which is undesirable, as the trapped organic vapor can cause the formation of void space in the resulting body of the PDC drill bit. Void spaces in the body of the PDC drill bit is undesired because the presence of void spaces in the body of the PDC drill bit means that the body of the PDC drill bit is porous, which can negatively affect the strength, ductility, and/or brittleness of the resulting body of the PDC drill bit.

In some implementations, after maintaining the plurality of polycrystalline diamonds and the matrix body material 502 deposited within the mold 501 at the infiltration temperature for the infiltration time duration, the plurality of polycrystalline diamonds and the matrix body material 502 deposited within the mold 501 are cooled at a cooling rate in a range of from about −1° C./min to about −40° C./min. In some implementations, the cooling rate is in a range of from about −2° C./min to about −20° C./min, from about −3° C./min to about −15° C./min, or from about −5° C./min to about −10° C./min. Cooling at quicker cooling rates may result in deformation (for example, cracking) of the resulting body of the PDC drill bit due to thermally induced stress. In some implementations, after the plurality of polycrystalline diamonds and the matrix body material 502 deposited within the mold 501 have been cooled, the formed PDC drill bit 100 is removed from the mold 501.

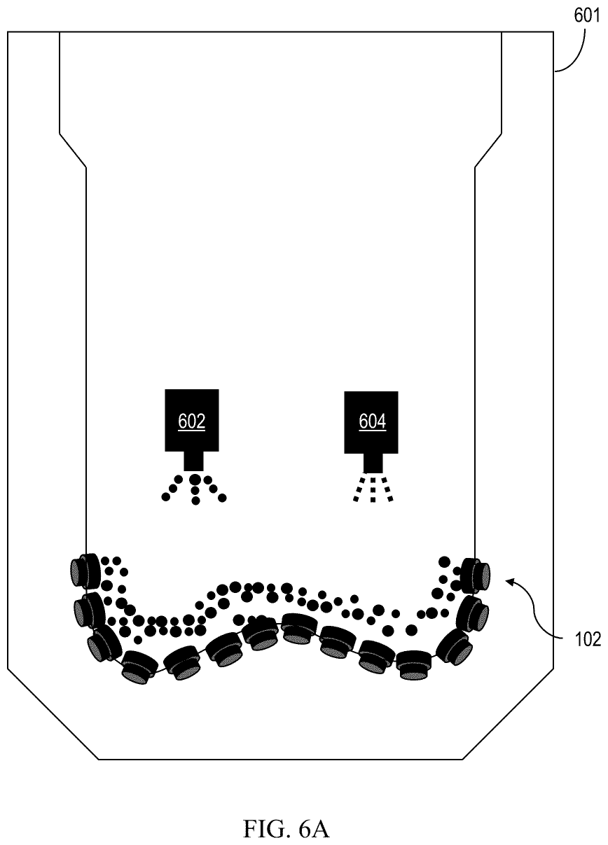

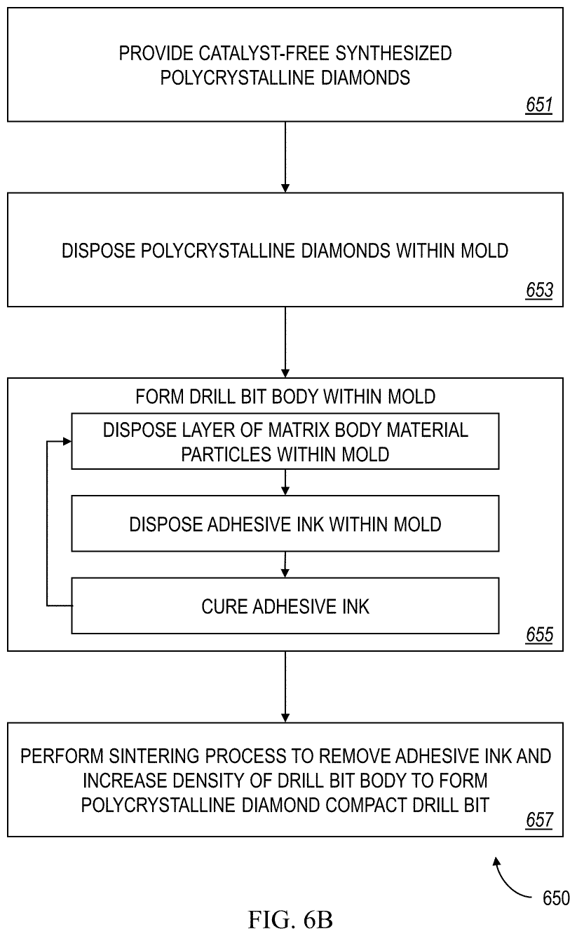

FIG. 6A is a schematic diagram of an example PDC drill bit being formed. In FIG. 6A, the plurality of PDC cutters 102 are already deposited within the mold 601. As mentioned previously, one or more of the PDC cutters 102 can be implementations of the PDC cutter 200, 300, 400, or any combination of these. With the PDC cutters 102 deposited within the mold 601, a drill bit body is formed within the mold 601. Forming the drill bit body within the mold 601 includes depositing a layer of matrix body material particles 602 within the mold 601. For example, the matrix body material particles 602 are sprayed into the mold 601 to form a layer within the mold 601. The matrix body material particles 602 can be substantially similar to the matrix body material 502. The matrix body material particles 602 can be made of, for example, copper, nickel, cobalt, iron, molybdenum, titanium, or an alloy based on any of these metals individually or any combination of these metals. In some implementations, the matrix body material particles 602 include an alloying element, such as manganese, tin, zinc, silicon, tungsten, boron, phosphorus, or any combination of these elements. In implementations in which certain levels of hardness, wear resistance, and erosion resistance are desired, additional “hard” particles can be provided as a reinforcement phase to the matrix body material particles 602. Such hard particles can include a carbide, such as tungsten carbide, silicon carbide, molybdenum carbide, titanium carbide, niobium carbide, tantalum carbide, chromium carbide, vanadium carbide, or any combination of these carbides. In some implementations, the hard particles include an oxide, a nitride, a silicide, a boride, or any combination of these compounds.

Forming the drill bit body within the mold 601 includes depositing an adhesive ink 604 within the mold 601. For example, the adhesive ink 604 is sprayed into the mold 601. The adhesive ink 604 can be, for example, a phenolic resin, a thermosetting polymer, wax, an ultraviolet light-curable photopolymer, an ultraviolet acrylic, a solvent-based polymer (such as polyimide or polyurethane), polyvinylpyrrolidone, a resin based from an amorphous fluoropolymer of tetrafluoroethylene, a silver-based ink, a gold-based ink, a platinum-based ink, a copper-based ink, or an aluminum-based ink. Forming the drill bit body within the mold 601 includes curing the adhesive ink 604 once it has been deposited within the mold 601. Curing the adhesive ink 604 can include, for example, exposing the adhesive ink 604 to ultraviolet light for a time duration in a range of from about 5 minutes to about 30 minutes. Curing the adhesive ink 604 can include, for example, simply allowing the adhesive ink 604 to cure on its own undisturbed for a time duration before proceeding to a subsequent step. Forming the drill bit body within the mold 601 can include repeating the steps of depositing the layer of matrix body material particles 602 within the mold 601, depositing the adhesive ink 604 within the mold 601, and curing the adhesive ink 604 in that order until the drill bit body is formed. Once the drill bit body has been formed, a sintering process can be performed to remove at least a portion of the cured adhesive ink 604 and increase a density of the drill bit body to form a PDC drill bit, for example, the PDC drill bit 100 shown in FIG. 1. The sintering process is described in more detail later.

FIG. 6B is a flow chart of an example method 650 for forming a PDC drill bit (such as the PDC drill bit 100) including a PDC cutter (such as the PDC cutter 200, 300, or 400). At block 651 a plurality of catalyst-free synthesized polycrystalline diamonds are provided. Each of the polycrystalline diamonds provided at block 651 have a cross-sectional dimension of at least 4 millimeters. For example, a plurality of the PDC cutters 200 are provided at block 651. For example, a plurality of the PDC cutters 300 are provided at block 651. For example, a plurality of the PDC cutters 400 are provided at block 651. For example, a plurality of the PDC cutters 200 and a plurality of the PDC cutters 300 are provided at block 651. For example, a plurality of the PDC cutters 200 and a plurality of the PDC cutters 400 are provided at block 651. For example, a plurality of the PDC cutters 300 and a plurality of the PDC cutters 400 are provided at block 651. For example, a plurality of the PDC cutters 200, a plurality of the PDC cutters 300, and a plurality of PDC cutters 400 are provided at block 651.

In some implementations, providing the plurality of polycrystalline diamonds at block 651 includes synthesizing each of the polycrystalline diamonds from diamond powder with a particle size within a range of from about 0.1 micrometers (μm) to about 50 μm. In some implementations, providing the plurality of polycrystalline diamonds at block 651 includes shaping each of the synthesized polycrystalline diamonds by laser cutting or mechanical grinding. In some implementations, the cross-sectional dimension of at least 4 millimeters for each of the polycrystalline diamonds provided at block 651 is a first cross-sectional dimension, and each of the polycrystalline diamonds has a second cross-sectional dimension greater than the first cross-sectional dimension. Examples of such implementations are shown by PDC cutters 300 (shown in FIGS. 3A and 3B) and 400 (shown in FIGS. 4A and 4B).

At block 653, the plurality of polycrystalline diamonds (provided at block 651) is deposited within a mold (such as the mold 601). After depositing the plurality of polycrystalline diamonds within the mold 601 at block 653, a drill bit body is formed within the mold 601 at block 655. Forming the drill bit body within the mold 601 at block 655 includes depositing a layer of matrix body material particles 602 within the mold 601. For example, the matrix body material particles 602 are sprayed into the mold 601 to form a layer within the mold 601 at block 655. Forming the drill bit body within the mold 601 at block 655 includes depositing an adhesive ink 604 within the mold 601. For example, the adhesive ink 604 is sprayed into the mold 601 at block 655. Forming the drill bit body within the mold 601 at block 655 includes curing the adhesive ink 604 once it has been deposited within the mold 601. Curing the adhesive ink 604 at block 655 can include, for example, exposing the adhesive ink 604 to ultraviolet light for a time duration. Curing the adhesive ink 604 at block 655 can include, for example, simply allowing the adhesive ink 604 to cure on its own undisturbed for a time duration before proceeding to a subsequent step. Forming the drill bit body within the mold 601 at block 655 can include repeating the steps of depositing the layer of matrix body material particles 602 within the mold 601, depositing the adhesive ink 604 within the mold 601, and curing the adhesive ink 604 in that order until the drill bit body is formed.

After the drill bit body has been formed at block 655, a sintering process is performed at block 657 to remove at least a portion of the cured adhesive ink 604 and increase a density of the drill bit body to form the PDC drill bit 100. The sintering process at block 657 includes heating the plurality of polycrystalline diamonds and the drill bit body to a sintering temperature greater than about 600° C. and less than about 1400° C. In some implementations, the sintering temperature is less than about 1000° C. In some implementations, the sintering temperature is in a range of from about 650° C. to about 1000° C. or from about 700° C. to about 850° C. In some implementations, the sintering temperature is about 750° C.

In some implementations, the sintering process at block 657 includes heating the plurality of polycrystalline diamonds and the drill bit body at a heating rate in a range of from about 1° C./min to about 40° C./min until the plurality of polycrystalline diamonds and the drill bit body reach the sintering temperature. In some implementations, the heating rate for the sintering process at block 657 is in a range of from about 2° C./min to about 20° C./min, from about 3° C./min to about 15° C./min, or from about 5° C./min to about 10° C./min. In some implementations, the sintering process at block 657 includes maintaining the plurality of polycrystalline diamonds and the drill bit body at the sintering temperature for a sintering time duration in a range of from about 10 minutes to about 360 minutes. In some implementations, the sintering time duration for the sintering process at block 657 is in a range of from about 20 minutes to about 180 minutes, from about 30 minutes to about 120 minutes, or from about 60 minutes to about 90 minutes. Heating at quicker heating rates and/or carrying out the sintering process for time durations that are shorter at block 657 may result in trapping organic vapor in the resulting body of the PDC drill bit, which is undesirable, as the trapped organic vapor can cause the formation of void space in the resulting body of the PDC drill bit. Void spaces in the body of the PDC drill bit is undesired because the presence of void spaces in the body of the PDC drill bit means that the body of the PDC drill bit is porous, which can negatively affect the strength, ductility, and/or brittleness of the resulting body of the PDC drill bit. Heating at quicker heating rates and/or carrying out the sintering process for time durations that are shorter at block 657 may result in incomplete bonding of the matrix body material particles 602 to each other and/or to the hard particles, which is undesirable because incomplete bonding can negatively affect the strength, ductility, and/or brittleness of the resulting body of the PDC drill bit.

In some implementations, after maintaining the plurality of polycrystalline diamonds and the drill bit body at the sintering temperature for the sintering time duration, the plurality of polycrystalline diamonds and the drill bit body are cooled at a cooling rate in a range of from about −1° C./min) to about −40° C./min. In some implementations, the cooling rate is in a range of from about −2° C./min to about −20° C./min, from about −3° C./min to about −15° C./min, or from about −5° C./min to about −10° C./min. Cooling at quicker cooling rates may result in deformation (for example, cracking) of the resulting body of the PDC drill bit due to thermally induced stress.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used in this disclosure, the term “about” or “approximately” can allow for a degree of variability in a value or range, for example, within 10%, within 5%, or within 1% of a stated value or of a stated limit of a range.

As used in this disclosure, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

1. A method comprising:
forming a plurality of catalyst-free synthesized polycrystalline diamonds using compressive pressures within a range of 10 Gigapascals (GPa) to 35 GPa and temperatures within a range of 2000 Kelvin (K) to 3000 K;
providing the plurality of polycrystalline diamonds, each of the polycrystalline diamonds having a cross-sectional dimension of at least 4 millimeters;
depositing the plurality of polycrystalline diamonds within a mold;
after depositing the plurality of polycrystalline diamonds within the mold, depositing a matrix body material within the mold; and
performing an infiltration process to bond the plurality of polycrystalline diamonds to the matrix body material and form a polycrystalline diamond compact (PDC) drill bit, wherein the infiltration process comprises heating the plurality of polycrystalline diamonds and the matrix body material deposited within the mold to an infiltration temperature greater than about 700 degrees Celsius (° C.) and less than about 1400° C.

2. The method of claim 1, wherein providing the plurality of polycrystalline diamonds comprises synthesizing each of the polycrystalline diamonds from diamond powder with a particle size within a range of from about 0.1 micrometers (μm) to about 50 μm.

3. The method of claim 2, wherein providing the plurality of polycrystalline diamonds comprises shaping each of the synthesized polycrystalline diamonds by laser cutting or mechanical grinding.

4. The method of claim 2, wherein, for each of the polycrystalline diamonds, the cross-sectional dimension of at least 4 millimeters is a first cross-sectional dimension, and each of the polycrystalline diamonds has a second cross-sectional dimension greater than the first cross-sectional dimension.

5. The method of claim 2, wherein the infiltration temperature is less than about 800° C.

6. The method of claim 2, wherein the infiltration temperature is about 800° C.

7. The method of claim 2, wherein the infiltration process comprises heating the plurality of polycrystalline diamonds and the matrix body material deposited within the mold at a heating rate in a range of from about 1° C. per minute (° C./min) to about 40° C./min until the plurality of polycrystalline diamonds and the matrix body material deposited within the mold reach the infiltration temperature.

8. The method of claim 7, wherein the infiltration process comprises maintaining the plurality of polycrystalline diamonds and the matrix body material deposited within the mold at the infiltration temperature for an infiltration time duration in a range of from about 10 minutes to about 180 minutes.

9. The method of claim 8, wherein the infiltration process comprises:
after maintaining the plurality of polycrystalline diamonds and the matrix body material deposited within the mold at the infiltration temperature for the infiltration time duration, cooling the plurality of polycrystalline diamonds and the matrix body material deposited within the mold at a cooling rate in a range of from about −1° C. per minute (° C./min) to about −40° C./min; and
removing the formed PDC drill bit from the mold.

10. A method comprising:
forming a plurality of catalyst-free synthesized polycrystalline diamonds using compressive pressures within a range of 10 Gigapascals (GPa) to 35 GPa and temperatures within a range of 2000 Kelvin (K) to 3000 K;
providing the plurality of polycrystalline diamonds, each of the polycrystalline diamonds having a cross-sectional dimension of at least 4 millimeters;
depositing the plurality of polycrystalline diamonds within a mold;
after depositing the plurality of polycrystalline diamonds within the mold, forming a drill bit body within the mold, wherein forming the drill bit body within the mold comprises:
(a) depositing a layer of matrix body material particles within the mold;
(b) depositing an adhesive ink within the mold;
(c) curing the adhesive ink; and
(d) repeating (a), (b), and (c) in order until the drill bit body is formed; and
after forming the drill bit body, performing a sintering process to remove at least a portion of the adhesive ink and increase a density of the drill bit body to form a polycrystalline diamond compact (PDC) drill bit, wherein the sintering process comprises heating the plurality of polycrystalline diamonds and the drill bit body to a sintering temperature greater than about 600 degrees Celsius (° C.) and less than about 1400° C.

11. The method of claim 10, wherein providing the plurality of polycrystalline diamonds comprises synthesizing each of the polycrystalline diamonds from diamond powder with a particle size within a range of from about 0.1 micrometers (μm) to about 50 μm.

12. The method of claim 11, wherein providing the plurality of polycrystalline diamonds comprises shaping each of the synthesized polycrystalline diamonds by laser cutting or mechanical grinding.

13. The method of claim 11, wherein, for each of the polycrystalline diamonds, the cross-sectional dimension of at least 4 millimeters is a first cross-sectional dimension, and each of the polycrystalline diamonds has a second cross-sectional dimension greater than the first cross-sectional dimension.

14. The method of claim 11, wherein the sintering temperature is less than about 1000° C.

15. The method of claim 11, wherein the sintering temperature is about 750° C.

16. The method of claim 11, wherein the sintering process comprises heating the plurality of polycrystalline diamonds and the drill bit body at a heating rate in a range of from about 1° C. per minute (° C./min) to about 40° C./min until the plurality of polycrystalline diamonds and the drill bit body reach the sintering temperature.

17. The method of claim 16, wherein the sintering process comprises maintaining the plurality of polycrystalline diamonds and the drill bit body at the sintering temperature for a sintering time duration in a range of from about 10 minutes to about 360 minutes.

18. The method of claim 17, wherein the sintering process comprises after maintaining the plurality of polycrystalline diamonds and the drill bit body at the sintering temperature for the sintering time duration, cooling the plurality of polycrystalline diamonds and the drill bit body at a cooling rate in a range of from about −1° C. per minute (° C./min) to about −40° C./min.
